(19) United States
(12) Patent Application Publication
(10) Pub. No.: US 2024/0293954 A1
(43) Pub. Date: Sep. 5, 2024

(54) METHOD TO REFINE WASTE WOOD-BASED MATERIAL

(71) Applicant: Välinge Innovation AB, Viken (SE)

(72) Inventor: Sofia BERGENDAL, Jonstorp (SE)

(73) Assignee: Välinge Innovation AB, Viken (SE)

(21) Appl. No.: 18/441,329

(22) Filed: Feb. 14, 2024

(30) Foreign Application Priority Data
Feb. 14, 2023 (SE) 2350138-0

(51) Int. Cl. B27N 1/00; B07B 1/28; B27N 3/06; B27N 3/10

(52) U.S. Cl. CPC B27N 1/00; B07B 1/28; B27N 3/06; B27N 3/10; B07B 2201/04

(57) ABSTRACT

A method to recycle waste wood-based material, including collecting a waste wood-based material resulting from sawing and/or machining in a wood-based material, separating the waste wood-based material by particle size, without prior grinding, by screening the waste wood-based material through at least one first screen to separate a first fraction of particles from the waste wood-based material, wherein the at least one first screen has apertures having an aperture width of 3000 μm or less, subsequently screening a remainder of the waste wood-based material through at least one second screen to separate a second fraction of particles from the waste wood-based material, wherein the at least one second screen has apertures having an aperture width exceeding 50 μm, and wherein a third fraction of particles is formed by particles from the waste wood-based material passing through the at least one second screen.

### CROSS REFERENCE TO RELATED APPLICATIONS

The present application claims the benefit of Swedish Application No. 2350138-0, filed on Feb. 14, 2024. The entire contents of Swedish Application No. 2350138-0 are hereby incorporated herein by reference in their entirety.

### TECHNICAL FIELD

Embodiments of the present disclosure relates to a method to refine and recycle waste material resulting from machining and/or sawing in wood-based materials.

### TECHNICAL BACKGROUND

When producing wood-based products, waste is produced in the form of, for example, saw dust and cut off material. The production waste may be formed when machining the wood-based material, for example by cutting, milling, sanding, planning, etc., a wood-based material. Production waste in the form of saw dust and/or removed wood material or particles may be formed from all type of woodworking.

In modern production of building panels, such as floor panels and furniture panels, waste material may be formed when sawing a board to individual panels, when sanding a surface, when machining bevels, tongues, and grooves and similar. If the floor panel or furniture panel is to be provided with a mechanical locking system for locking both in a horizontal direction and a vertical direction, several machining steps may be performed, such as cutting, milling, and calibrating of surfaces to the intended shape.

All removed material during woodworking, such as in the form of saw dust, wood particles, wood fibres, splinters, or chunks, has to be gathered, for example, by being conveyed via a suction hose to a container, in order to maintain a safe and healthy working environment. Fine wood dust material may lead to dust explosions under certain circumstances.

The waste material may be combusted. However, there is a desire to recycle the material, especially when producing products including wood particles or wood fibres. Including the waste material into the production process when producing new products would be beneficial from many aspects, including environmental aspects. Waste material may replace virgin wood fibres or any other type of filler in the production.

However, the large particle size distribution in the waste material, ranging from particles having a size of 50 μm or less to wood fibres having a length of 100 mm or more, has proven it difficult to simply replace current raw material with waste material in the production process. An attempt is to grind the waste material to particles having a narrower particle size distribution in order to replace current filler material in the production process. However, such grinding process is energy consuming. In some processes, the waste material is dried after grinding to lower a moisture content thereof before the waste material can be sieved to the desired particle size distribution. This may be common procedure when material is sieved through finer apertures, e.g. less than 400μ, of the screens.

### SUMMARY

It is an object of at least embodiments of the present disclosure to provide an improvement over the above described techniques and known art.

According to a first aspect of the disclosure, a method to refine waste wood-based material is provided. The method may comprise:

collecting a waste wood-based material resulting from sawing and/or machining in a wood-based material,

separating the waste wood-based material by particle size by screening the waste wood-based material through at least one first screen to separate a first fraction of particles from the waste wood-based material, wherein the at least one first screen has apertures having an aperture width of 3000 μm or less,

subsequently screening a remainder of the waste wood-based material through at least one second screen to separate a second fraction of particles from the waste wood-based material, wherein the at least one second screen has apertures having an aperture width exceeding 50 μm, and

wherein a third fraction of particles is formed by particles from the waste wood-based material passing through the at least one second screen.

Refining in the present disclosure refers to refining by removing undesired particles from the waste wood-based material. The particles may be undesired by their size, such as removing coarse particles and/or fines, and/or may be undesired by their shape, such as removing particles having an undesired shape.

Such refining may at least improve processability and handling of the remaining waste wood-based material, for example, in subsequent processes to recycle the waste wood-based material.

The first fraction of particles is formed by particles not passing through the at least one first screen.

The second fraction of particles is formed by particles not passing through the at least one second screen.

The third fraction of particles is formed by particles passing through the at least one first screen and the at least one second screen.

The aperture width of the at least one first screen may exceed the aperture width of the at least one second screen.

The method may be performed in one single screening device, comprising the at least one screen and the at least one second screen.

The screening of the waste wood-based material by means of the at least one screen and the at least second screen is performed without intermediate processes, such as drying.

When discussing drying herein drying is defined or considered to be an active process step and not a side effect of another process step, such as grinding.

Separating the waste wood-based material may be performed without prior grinding. Screening allows for providing particles from waste wood-based material having a desired particle size distribution without grinding all waste wood-based material to the desired particle size distribution.

The waste wood-based material may not be ground prior to screening. The waste wood-based material may not be machined prior to screening.

Screening of the waste wood-based material can be performed without prior grinding of the waste wood-based material. Screening of the waste wood-based material can be performed without prior drying of the waste wood-based material.

A size of fibres and/or particles forming the waste wood-based material remains substantially unaffected prior to screening.

A size of fibres and/or particles forming the waste wood-based material remains substantially unaffected during separating.

The first fraction of particles may be a coarse fraction of particles. Another term that may be used for the first fraction of particles is oversized fraction of particles. The second fraction of particles may be a utility fraction of particles. Another term that may be used for the second fraction of particles is work fraction of particles. The third fraction of particles may be a fine fraction of particles. Another term that may be used for the third fraction of particles is dust fraction of particles.

The second fraction of particles may be used in a subsequent process for producing a building panel, or may be used in a subsequent process for forming a part of a building panel. The second fraction of particles may be used without further processing, for example without grinding or drying. Thereby, the waste wood-based material can be recycled into a new product. The method is intended to remove coarse particles and/or fines which may be difficult to handle in the subsequent process.

Screening a remainder of the waste wood-based material refers to screening the waste wood-based material that has passed through the at least one first screen. Waste wood-based material that has passed through the at least one first screen is fed, for example by gravity, to the at least second screen. Waste wood-based material that has passed through the at least one first screen and the at least one second screen forms the third fraction of particles.

The waste wood-based material may be formed when sawing, machining such as planning, cutting, milling, and calibrating in a wood-based material. The waste wood-based material may be in the form of saw dust, particles and/or fibres. The wood-based material may be a wood-based board material, such as MDF, HDF, OSB, particle board. The wood-based material may comprise solid wood and/or wood veneer. The wood-based material may comprise a component other than wood, such binder, additives, fillers, such as organic fillers and inorganic fillers, paper material as in case of a laminate board.

The second fraction of particles from the waste wood-based material may be used as feedstock in a method to produce a building panel, or part of a building panel. The second fraction of particles from the waste wood-based material may replace virgin raw material, such as virgin wood fibre or virgin wood particles, in the method to produce a building panel, or part of a building panel.

The waste wood-based material may be screened without prior drying of the waste wood-based material. The waste wood-based material may not be dried prior to screening. A moisture content may be at least 3%. The moisture content may be defined as mass prior to drying minus mass after dried divided by the mass after drying.

An average particle size of the second fraction of particles from the waste wood-based material may be less than an average particle size of the first fraction of particles. An average particle size of the second fraction of particles from the waste wood-based material may be exceeding an average particle size of the third fraction of particles.

At least 60 wt. % of the particles of the second fraction of particles from the waste wood-based material may have a size in a range of 100-400 μm in a sieving analysis as described under section “Example 2: Method description of sieving analysis” in the present disclosure.

At least 60 wt. % of the particles of the first fraction of particles from the waste wood-based material may have a size exceeding 400 μmin a sieving analysis as described under section “Example 2: Method description of sieving analysis” in the present disclosure.

At least 60 wt. % of the particles of the third fraction of particles from the waste wood-based material may have a size being less than 100 μm in a sieving analysis as described under section “Example 2: Method description of sieving analysis” in the present disclosure.

An aperture width of the apertures of the at least one second screen may be less than an aperture width of the apertures of the at least one first screen.

The at least one first screen may comprise a set of first screens. The number of screens in the set of first screens may be 1-3.

The at least one first screen may be at a non-zero angle relative to a horizontal plane. If a set of first screens is provided, at least one of the first screens may be at a non-zero angle relative to a horizontal plane.

The at least second screen may comprise a set of second screens. The number of screens in the set of second screens may be 1-3.

The at least second screen may be at a non-zero angle relative to a horizontal plane. If a set of second screens is provided, at least one of the second screens may be at a non-zero angle relative to a horizontal plane.

The aperture width of each screen in the first set or screens may exceed the aperture width of each screen in the second set of screens.

The at least one first screen may have apertures having an aperture width in a range of 450 to 3000 μm. If the at least one first screen comprises a set of first screens, each first screen may have apertures having an aperture width in a range of 450 to 3000 μm.

The at least one second screen may have apertures having an aperture width in a range of 50 to 600 μm, or 50 to 400 μm. If the at least one second screen comprises a set of second screens, each second screen may have apertures having an aperture width in a range of 50 to 400 μm.

The at least one first screen, or the screens in the set of first screens, may have apertures having an aperture width in a range of 450 to 3000 μm. The at least one second screen, or the screens in the set of second screens, may have apertures having an aperture width in a range of 50 up to 600 μm.

The at least one first screen, or the screens in the set of first screens, may have apertures being larger than the apertures of the at least one second screen, or the screens of the set of second screens. For example, if the apertures of the second screen are 600 μm, the apertures of the first screen are at least in the range of more than 600, not including 600 μm, to 3000 μm.

The at least one first and/or second screen may comprise chains arranged on the at least one first and/or second screen. If a set of first screens is provided, at least one of the first screens may comprise chains. If a set of second screens is provided, at least one of the second screens may comprise chains.

The at least one first and/or second screen may be vibrating. If a set of first screens is provided, at least one of the first screens may be vibrating. If a set of second screens is provided, at least one of the second screens may be vibrating.

The at least one first and/or second screen may be vibrating with a stroke of 1.5-8 mm., such as 2-4 mm., or 7-8 mm. If a set of first screens is provided, at least one of the first screens may be vibrating with a stroke of 7-8 mm. If a set of second screens is provided, at least one of the second screens may be vibrating with a stroke of 7-8 mm.

The method may further comprise grinding the first fraction of particles from the waste wood-based material after screening. The first fraction of particles, being oversized particles, may be ground to reduce the particle size.

After being ground, the first fraction of particles may be processed according to the method disclosed above.

After being ground, the first fraction of particles may be separated by screening, for example, according to the method disclosed above.

After being ground, the first fraction of particles may be mixed with waste wood-based material.

The method may further comprise compacting the third fraction of particles from the waste wood-based material to pellets after screening. The third fraction of particles, being fine particles, may be compacted to pellet fuel.

The second fraction of particles from the waste wood-based material may be used in a process to produce a building panel or board, or to a part of a building panel or board.

The second fraction of particles from the waste wood-based material may be a material in subsequent method steps, for example to produce a building panel or board, or to produce a part of a building panel or board.

The method, or a subsequent method, may further comprise applying particles from the second fraction of particles and a binder on a substrate, and applying heat and pressure to the particles, the binder, and the substrate to form a building panel, or a part of a building panel.

The method, or a subsequent method, may further comprise applying a wood veneer layer on the particles from the second fraction of particles and the binder prior to applying heat and pressure, wherein after applying heat and pressure, the particles, the binder, and the wood veneer layer form a surface layer of the building panel.

According to a second aspect, a method to recycle waste wood-based material is provided. The method comprises applying particles from the second fraction of particles obtained by the method according to the first aspect and a binder on a substrate, and applying heat and pressure to the particles, the binder, and the substrate to form a building panel, or a part of a building panel.

The method may further comprise applying a wood veneer layer on the particles and the binder prior to applying heat and pressure, wherein after applying heat and pressure, the particles, the binder, and the wood veneer layer form a surface layer of the building panel.

According to a third aspect, a building panel is provided. The building panel comprises a surface layer arranged on a substrate, wherein the surface layer comprises a binder and particles from the second fraction of particles from waste wood-based material obtained from the method according to the first aspect.

The surface layer may comprise a wood veneer layer arranged on a sub-layer formed by the particles from the second fraction of particles and the binder.

### BRIEF DESCRIPTION OF THE DRAWINGS

The present disclosure will by way of example be described in more detail with reference to the appended schematic drawings, which show embodiments of the present disclosure.

FIG. 1 shows schematically a screening device in cross-section according to a first example.

FIG. 2 shows a portion of an example screen in more details.

FIG. 3 shows a portion of an example screen provided with chains.

FIG. 4 shows an example of a particle or fibre in cross-section.

FIG. 5 shows schematically a screening device in cross-section according to a second example.

FIG. 6 shows an example of a method to produce a building panel.

FIG. 7 shows an example of a process of separating waste wood-based material.

### DETAILED DESCRIPTION OF EMBODIMENTS

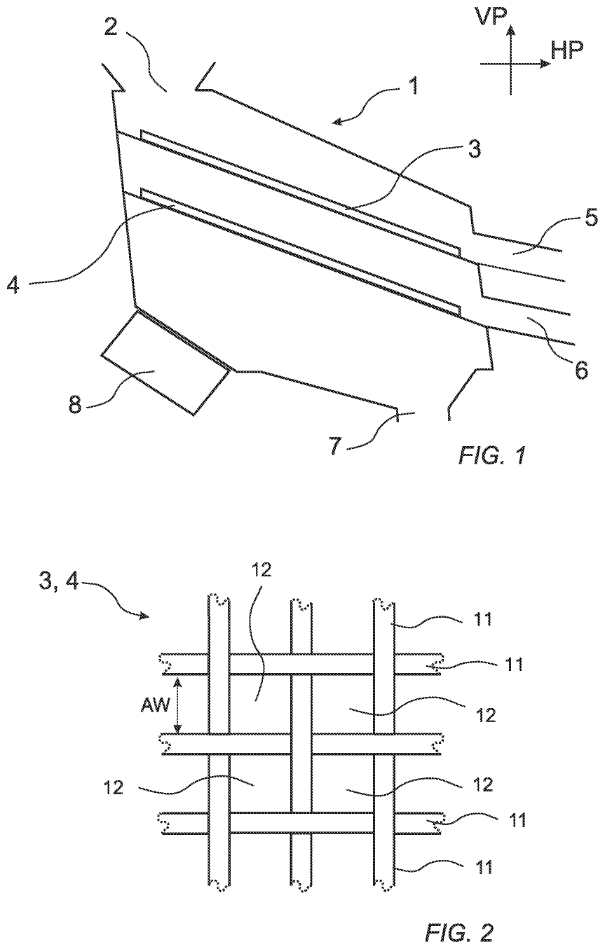

FIG. 1 shows an example of a screening device 1 as seen in cross-section. The screening device, or sizer, in FIG. 1 comprises a first screen 3 and a second screen 4.

The first screen 3 is at a non-zero angle relative to a horizontal plane HP. The first screen 3 may be angled with an angle of 5-60° relative to the horizontal plane HP. The first screen 3 may have a planar extension, which may be extending in a plane being at a non-zero angle relative to the horizontal plane HP. The first screen 3 may be angled with an angle being less than 90° relative to the horizontal plane HP, such as not being vertical.

The second screen 4 is at a non-zero angle relative to a horizontal plane HP. The second screen 4 may be angled with an angle of 5-60° relative to the horizontal plane HP. The second screen 4 may have a planar extension, which may be extending in a plane being at a non-zero angle relative to the horizontal plane HP. The second screen 4 may be angled with an angle being less than 90° relative to the horizontal plane HP, such as not being vertical.

The first screen 3 and the second screen 4 may be non-parallel.

The first screen 3 and/or the second screen 4 may be moveable during screening in a vibrating movement. The first screen 3 and the second screen 4 may be connected to one or more vibrator motors 8 configured to the first screen 3 and the second screen 4.

The first screen 3 and/or the second screen 4 may be moveable with a stroke of 1.5-8 mm., such as 2-4 mm. or 7-8 mm.

The first screen 3 and/or the second screen 4 may be moved during screening, such as in a vibrating movement. The movement direction of the first screen 3 may be at a non-zero angle relative to a horizontal plane HP, such as at an angle of 5-60° relative to the horizontal plane HP. The movement direction of the second screen 4 may be at a non-zero angle relative to a horizontal plane HP, such as at an angle of 5-60° relative to the horizontal plane HP.

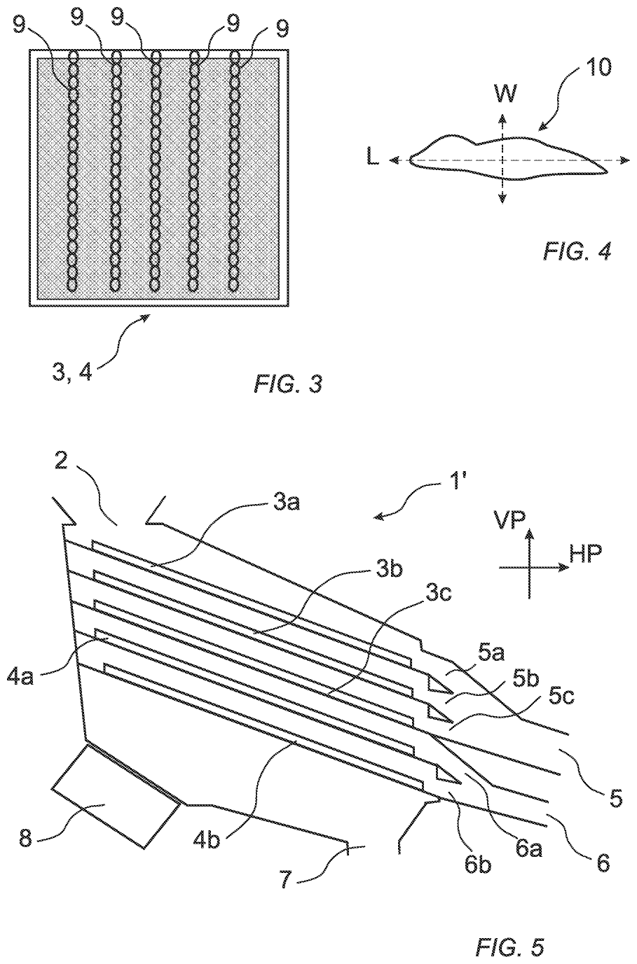

The first screen 3 and/or the second screen 4 may be provided with one or more chains 9, as shown in FIG. 3. The chains 9 may be arranged on the first screen 3 and/or on the second screen 4. At least one end of the chains 9 may be attached to at least one edge of a frame enclosing the first screen 3 and/or the second screen 4. The chains 9 are adapted to clean the screen 3, 4 when screening, due to the vibration movement of the screens 3, 4. Thereby, the risk for so called blinding is at least reduced.

The chains 9 may be made of metal, such as steel, or a polymer material, such as a thermoplastic material, for example polyamide.

Any of the screens, i.e., the first screen 3, the second screen 4, may be of a type shown in more details in FIG. 2. The screen may also be referred to as a screen cloth. The screen may be in the form of a mesh. The mesh may be formed of wires 11, such as metal wires or plastic wires. The metal wires may be formed of stainless steel.

An opening between adjacent wires defines an aperture 12, or mesh aperture. The aperture 12 may have a rectangular shape, such as a substantially square shape. Thus, for a square shaped aperture 12 having for equal sides, all sides have the same aperture width AW. In an example of an aperture not having equal sides, the aperture width AW is defined in a width direction and an aperture length is defined in a length direction, wherein the length exceeds the width of the aperture.

The apertures 12 may have a uniform aperture width. In other examples, the aperture width may vary between the apertures 12.

The screening device 1 is used in a process for separating waste wood-based material by particle size. The waste wood-based material may be formed when sawing and/or machining in a wood-based material. Machining may be a planning, cutting, milling, and calibrating in a wood-based material. The waste wood-based material formed by machining and sawing may be in range variety of sizes, from saw dust to larger sized particles and/or fibres. Larger sized particles and fibres may have a size of several millimetres, such as 1-100 mm.

When producing building panels, for example floor panels, wall panels and furniture panels, waste material may be formed when dividing by sawing a board into individual panels, and when machining a mechanical locking system, by sawing, cutting, milling, and calibrating elements of the mechanical locking system, such as locking surfaces, grooves, tongues, recess, etc. Further waste material may be formed when machining bevels, grooves, and decorative elements in the building panels.

The waste material is formed from the material which has been machined in the production process. In case of building panels, the material is conventionally a wood-based material. The wood-based material may be a wood-based board material, such as MDF, HDF, OSB, particle board. Board materials as MDF, HDF, OSB, particle board, are conventionally used as board material in building panels. Such board material may also be referred to as a core of the building panels. The board material may be machined when forming the mechanical locking system. In other examples, the wood-based material may comprise solid wood and/or wood veneer, such as machining a building panel or board having a solid wood surface or a wood veneer surface. The wood-based material may comprise a component other than wood, such binder, additives, or paper material as in case of a machining laminate board. Waste material formed from machining board materials such as MDF, HDF, OSB, particle board may also comprise binders.

Machining refers to any process other than crushing and grinding the waste wood-based material.

The waste wood-based material must be removed from the manufacturing facilities, for example due to health considerations and safety considerations.

Instead of combustion of the waste wood-based material, the waste wood-based material can be recycled into a production process. The waste wood-based material can be used as feedstock, in a process to produce a building panel or board, or part of a building panel or board. Due to the size variation, grinding the waste wood-based material has previously been used to reduce the size variations of the waste wood-based material. However, grinding is an energy consuming process, wherein a major part of the energy consumed is not used for breaking bonds for achieving the desired size reduction. The energy used for breaking bonds to achieve the desired size reduction is very small (<1%) in relation to the total energy input in the grinding process, as mentioned in Handbook of Powder Science and Technology, Second edition, Chapman and Hall, Edited by Muhammad E. Fayed and Lambert Otten, 1997. Consequently, grinding particles for achieving size reduction is inefficient in view of the energy consumption.

In the present disclosure, the waste wood-based material is separated by size by screening. Screening of the waste wood-based material can be performed without prior grinding of the waste wood-based material. Screening of the waste wood-based material can be performed without prior drying of the waste wood-based material.

However, it is not excluded that material prior to being waste has been dried, and/or that the material prior to being waste has been grinded. For example, a wooden board may have been dried and thereafter formed a core of building panel. A further example is that fibres forming a wood fibre based board such as HDF may have been grinded prior to forming the wood fibre based board. However, machining the building panel, such as the wooden board or the wood fibre based board, may result in waste wood-based material, which can be screened according to the present disclosure, without prior drying, and/or prior grinding.

Screening by size is made to improve the processability of the material, thereby allowing the waste wood-based material to be recycled in a method to produce a building panel or a part of a building panel, and allowing the waste wood-based material to be recycled with a high outcome. Improved processability is intended to refer to higher outcome by each unit of input material, for example by reduced number of production stops.

It is known that a large differentiation in particle size may result in difficulties during the production process. Branched particles, particles being bent and/or being irregularly shaped particles may as well result in processability problems during the production process.

Further, large particles, particles having an elongated shape as shown in FIG. 4, and/or being branched, bent, irregularly shaped or otherwise having a high surface area may be difficult to process and handle due to mechanical interlocking and sterically hindering. Mechanical interlocking and sterically hindering of particles may result in bridge building in production equipment, which leads to maintenance stops, and consequently low outcome of material.

Large particles, particles having an elongated shape, and/or being branched, bent, irregularly shaped or otherwise having a high surface area have difficulties to pass screens, even if the aperture width of the screen exceeds the particles size, due to their irregular shape.

Fine particles may result in blockage in production equipment. Combined problems associated with bridge building and blockage may also arise, wherein bridge building leads to blockage.

By screening the particles into at least three different fractions, problems described above are at least reduced, thereby allowing recycling of waste wood-based material in an efficient way.

In the present disclosure, the waste wood-based material may be gathered or collected when machining the wood-based material. The waste wood-based material may be stored prior to being further processed. The waste wood-based material may originate from the same production site where the waste wood-based material will be used as feedstock, or have a different origin.

A batch of the waste wood-based material may be conveyed to an inlet 2 of the screening device 1, as shown in FIG. 1. The waste wood-based material may be unprocessed prior to being separated in the screening device 1. The waste wood-based material may not have been dried prior to being separated in the screening device 1. The wood-based material may have a moisture content of 3% or more when entering into the screening device 1.

The waste wood-based material is fed to the first screen 3. A portion of the wood-based material has a size not allowing the particles or fibres of waste wood-based material to pass through the apertures 12 of the first screen 3. The portion of the waste wood-based material not passing through the apertures 12 of the first screen 3 forms a first fraction of particles. The first fraction of particles leaves the screening device through a first outlet 5 of the screening device 1.

In one example, the first screen 3 has an aperture width AW of 3000 μm or less. The first screen 3 may have an aperture width AW in a range of 450 to 3000 μm.

A consequence of the first screen 3, or any screen in the present disclosure, being at a non-zero angle relative to the horizontal plane is that particles that can pass through the apertures in the first screen 3 have a particle size less than the aperture width. Due to the inclination of the first screen 3, there is more likely to exist an actual aperture though which the particles can pass that are smaller than if the first screen 3 had been arranged parallel to the horizontal plane HP.

At least 60% of the first fraction of particles, i.e., the particles that do not pass through the first screen 3, may have a particle size exceeding 400 μm in a sieving analysis as described undersection “Example 2: Method description of sieving analysis” in the present disclosure.

When the particle 10 hits the first screen 3 or the second screen 4, the particle 10 can be oriented such that the particle 10 may pass through the screen even if the particle 10 has a length exceeding the size of the aperture 12. The particle 10 may be oriented such that its length direction is substantially perpendicular to the plane of the screen. In this orientation, the largest width of the particle 10 is decisive of whether the particle 10 can pass through the aperture of the screen. FIG. 4 shows a particle having an elongated shape, having a length in a length direction L exceeding its width in a width direction W.

The first fraction of particles may be collected in a container (not shown), e.g., downstream of the first outlet 5. Further processing of the first fraction of particles will be described below. The first fraction of particles can be considered as an oversized fraction of the waste wood-based material.

A remainder of the waste wood-based material that was fed into the screening device 1 are fed to the second screen 4. As illustrated in FIG. 1, the remainder of the waste wood-based material falls down on the second screen 4 by gravity. The remainder of the waste wood-based material is formed by the particles from the waste wood-based material that have passed through the first screen 3.

A portion of the remainder of the waste wood-based material has a size not allowing the particles or fibres of the waste wood-based material to pass through the apertures 12 of the second screen 4. The portion of the waste wood-based material not passing through the apertures 12 of the second screen 4 form a second fraction of particles. The second fraction of particles leaves the screening device through a second outlet 6 of the screening device 1.

The second screen 4 has apertures having an aperture width AW being less than the aperture width AW of the apertures of the first screen 3.

In one example, the second screen 4 has an aperture width AW exceeding 50 μm, such as exceeding 100 μm, such as exceeding 150 μm. The second screen 4 may have an aperture width AW in a range of 50 to 450 μm, such as in a range of 150-400 μm.

A consequence of the second screen 4, or any screen, being at a non-zero angle relative to the horizontal plane HP is that particles that can pass through the apertures in the second screen 4 have a particle size less than the aperture width. Due to the inclination of the second screen 4, there is more likely to exist an actual aperture through which the particles can pass that are smaller than if the second screen 4 had been arranged parallel to the horizontal plane HP.

At least 60% of the second fraction of particles, i.e., the particles have passed through the first screen 3 but do not pass through the second screen 4, may have a particle size in a range of 100-400 μm in a sieving analysis as described under section “Example 2: Method description of sieving analysis” in the present disclosure.

The second fraction of particles may be collected in a container (not shown), e.g., downstream of the second outlet 6. Further processing of the second fraction of particles will be described below. The second fraction of particles can be considered as a use fraction of the waste wood-based material.

The particles that pass through the second screen 4 form the third fraction of particles. The third fraction of particles may be considered as a fine fraction of particles.

At least 60% of the third fraction of particles, i.e., the particles have passed through the second screen 4, may have a particle size less than 100 μm in a sieving analysis as described under section “Example 2: Method description of sieving analysis” in this disclosure.

The third fraction of particles leaves the screening device through a third outlet 7, e.g., below the second screen 4. The third fraction of particles may be collected in a container (not shown), e.g., downstream of the third outlet 7. Further processing of the third fraction of particles will be described below.

In another example of a screening device 1′, the first screen comprises more than one first screen, such a set of first screens, and the second screen comprises more than one second screen, such as a set of second screens. Such a screening device 1′ is shown in FIG. 5.

The above description with reference to the first screen 3 and the second screen 4 is applicable to at least one of the first screens and at least one of the second screens, respectively.

The screening device 1′ shown in the example in FIG. 5 comprises a set of first screens and a set of second screens. The set of first screens comprises first screens 3a, 3b, 3c. The set of second screens comprises second screens 4a, 4b.

An aperture width of the apertures of the screens in the first set of screens 3a, 3b, 3c exceeds an aperture width of the apertures of the screens in the second set of screens 4a, 4b.

As previously described with reference to FIG. 1, the screening device 1′ may comprises an inlet 2, a vibration motor 8 configured to vibrate the set of first screens 3a, 3b, 3c and the set of second screens 4a, 4b, and a plurality of outlets 5, 6.

The set of first screens 3a, 3b, 3c and the set of second screens 4a, 4b, as previously described with reference to FIG. 2, may be provided with chains of the type described with reference to FIG. 3.

Each of the screens 3a, 3b, 3c, 4a, 4b of the first set and the second set may be of the type described above with reference to FIG. 2.

Waste wood-based material of the above described type is fed to the inlet 2 of the screening device 1′. The waste wood-based material may be unprocessed prior to being separated in the screening device 1′. The waste wood-based material may not be dried prior to being separated in the screening device 1′. The wood-based material may have a moisture content of 3% or more when entering into the screening device 1′.

The waste wood-based material is fed to the first set of screens 3a, 3b, 3c. The waste wood-based material is fed to an upper first screen 3a. The upper first screen 3a may have apertures having an aperture width AW exceeding an aperture width of any of the other screens of the first set of screens and of the second set of screens. In one example, the upper first screen 3a may have apertures having an aperture width AW in a range of 1000 to 3000 μm, for example about 2000 μm. Particles not passing through the upper first screen 3a are guided to a first outlet 5a.

Particles passing through the upper first screen 3a, i.e., a remainder of the waste wood-based material, are fed, for example by gravity, to an intermediate first screen 3b. The intermediate first screen 3b may have apertures having an aperture width AW exceeding an aperture width AW of the lower first screen 3a. The aperture width of the intermediate first screen 3b may less than the aperture width of the upper first screen 3a. In one example, the intermediate first screen 3b may have apertures having an aperture width in the range of 500 to 900 μm, for example about 720 μm. Particles not passing through the upper intermediate screen 3b are guided to a second outlet 5b.

Particles passing through the upper first screen 3a and the intermediate first screen 3b are fed, for example by gravity, to a lower first screen 3c. The lower first screen 3c may have apertures having an aperture width being less than the aperture width of the upper first screen 3a and the intermediate first screen 3b. In one example, the lower first screen 3c may have apertures having an aperture width in the range of 450 to 500 μm, such as about 450 μm. Particles not passing through the lower intermediate screen 3c are guided to a third outlet 5c.

Particles not passing through any of the screens in the first set of screens, i.e., the upper first screen 3a, the intermediate first screen 3b and the lower first screen 3c, form a first fraction of particles. The first outlet 5a, the second outlet 5b, and the third outlet 5 are joined in a first fraction outlet 5.

At least 60% of the first fraction of particles, i.e., the particles that do not pass through the first screen 3 or first set of screens 3a, 3b, 3c, may have a particle size exceeding 400 μm in a sieving analysis as described under section “Example 2: Method description of sieving analysis” in the present disclosure.

The first fraction of particles may be collected in a container (not shown), e.g., downstream of the first fraction outlet 5. Further processing of the first fraction of particles will be described below. The first fraction of particles can be considered as an oversized fraction of the waste wood-based material.

Particles passing through the upper first screen 3a, the intermediate first screen 3b and the lower first screen 3c are fed, for example by gravity, to the second set of screens 4a, 4b.

The second set of screens comprises an upper second screen 4a and a lower second screen 4b.

Particles passing through the set of first screens 3a, 3b, 3c are fed to the upper second screen 4a. The upper second screen 4a have an aperture width exceeding an aperture width of the lower second screen 4b. The aperture width of the upper second screen 4a is less than the aperture width of any screen in the first set of screens. In one example, the upper second screen 4a may have apertures having an aperture width in the range of 315 to 380 μm. Particles not passing through the upper second screen 4a are guided to a fourth outlet 6a.

Particles passing through the upper second screen 4a are fed, for example by gravity, to the lower second screen 4b. The lower second screen 4b have an aperture width being less than the aperture width of the upper second screen 4b. In one example, the lower second screen 4b may have apertures having an aperture width in the range of 50 to 300 μm, such as 50 to 200 μm. Particles not passing through the lower second screen 4b are guided to a fifth outlet 6b.

Particles not passing the upper second screen 4a or the lower second screen 4b form a second fraction of particles. The fourth outlet 6a and the fifth outlet 6b, are joined in a second fraction outlet 6.

At least 60% of the second fraction of particles, i.e., the particles having passed through the first set of screens 3a, 3b, 3c but not passing through the second set of screens 4a, 4b, may have a particle size in a range of 100-400 μm in a sieving analysis as described under section “Example 2: Method description of sieving analysis” in the present disclosure. The second fraction of particles may be collected in a container (not shown). Further processing of the second fraction of particles will be described below. The second fraction of particles can be considered as a utility fraction of the waste wood-based material.

The particles that pass through the upper second screen 4a and the lower second screen 4b form the third fraction of particles. The third fraction of particles may be considered as a fine fraction of particles.

At least 60% of the third fraction of particles, i.e., the particles have passed through the upper and lower second screens 4a, 4b, may have a particle size less than 100 μm in a sieving analysis as described under section “Example 2: Method description of sieving analysis” in this disclosure.

The third fraction of particles leaves the screening device through a fine fraction outlet 7. The third fraction of particles may be collected in a container (not shown), e.g., downstream of the fine fraction outlet 7. Further processing of the third fraction of particles will be described below.

At least one of the screens in the first set of screens 3a, 3b, 3c may be inclined relative the horizontal plane HP. In the example shown in FIG. 5, all screens in the first set of screens 3a, 3b, 3c are inclined.

At least one of the screens in the second set of screens 4a, 4b may be inclined relative the horizontal plane HP. In the example shown in FIG. 5, all screens in the second set of screens 4a, 4b are inclined.

The first fraction, which may be considered as an oversized fraction, may be further processed in order to reduce the size of the particles and/or the fibres of the first fraction. The first fraction of particles may be ground after screening. Thereby, the size of the particles can be reduced. After grinding, the first fraction of particles may be once again separated in the screening device 1′ to be separated by particle size. The first fraction of particles may be gathered together with the waste wood-based material that has not yet been screened, or stored separately from the waste wood-based material.

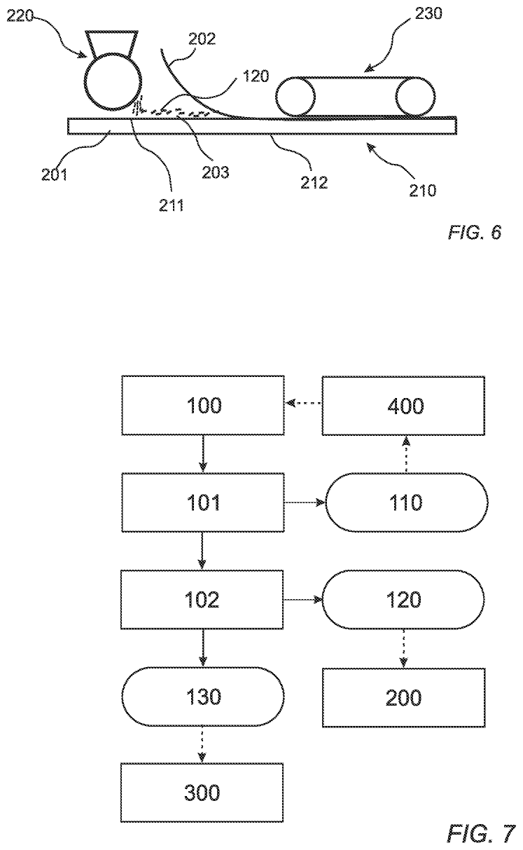

The second fraction of particles, which may be considered as the utility fraction, may be used as feedstock or raw material in a method to produce a building panel 210, or a part of a building panel 210, which is shown in FIG. 6. Thereby, the waste wood-based material can be recycled into a new product, such as a building panel, or part of a building panel. The second fraction below 120 includes particles originating from the second fraction of particles obtained from the waste wood-based material. The second fraction of particles may be applied, for example by scattered using a scattering device 220, on a first surface 211 of a core 201. The core 201 may be wood-based board, such as a MDF, HDF, particle board, lamella core, etc. The second fraction of particles 120 may be applied directly on the first surface 211 of the core 201. The second fraction of particles 120 may be applied together with virgin fibre material, or replace all other virgin fibre material.

The second fraction of particles 120 may be mixed with a binder 203, or the binder 203 may be applied separately from the second fraction of particles 120. For example, the binder 203 may be applied prior to applying the second fraction of particle 120, or be applied on the second fraction of particles 120. In the example illustrated in FIG. 6, the binder 203 is mixed with the second fraction of particles 120. The binder 203 may be a thermoplastic binder or a thermosetting binder. The thermosetting binder may be an amino resin, such as melamine formaldehyde or urea formaldehyde, or a combination thereof.

The second fraction of particles 203 may form, or form part of, a sub-layer arranged on the first surface 211 of the core 201. The second fraction of particles 120 and the binder 203 may together form the sub-layer. The sub-layer may be intended to form, or form part of, a surface layer of the building panel 210. A wood veneer layer 202 may be arranged on the sub-layer, which is illustrated in FIG. 6. In another example, the second fraction of particles 120 together with the binder form 203 a surface layer of the building panel 210.

The second fraction of particles 120 may also be applied on a second surface 212 of the core 201, opposite the first surface 211 of the core 201 (not shown). The second fraction of particles 120 applied on the second surface 212 of the core 201 may form, or form part of, a balancing layer (not shown), optionally together with a binder of the above described type.

The core 201, the second fraction of particles 120 and the binder 203 applied on the first surface 211 of the core 201, and/or the second surface 212 of the core 201, are pressed to each other by applying heat and pressure. If the wood veneer layer 202 is included, the core 201, the sub-layer arranged on the first surface 211 of the core 201, the sub-layer including the second fraction of particles 120 and the binder 203, and the wood veneer layer 202 arranged on the sub-layer are pressed together by applying heat and pressure. Heat and pressure may be applied in a static or continuous pressing device 230.

Pressing may comprise applying a pressure of at least 10 bar and a temperature of at least 130° C. during a pressing time of at least 10 s. Pressure applied may be in the range of 10-80 bar. Pressure may be applied during 10-90 s. The temperature may be 130-235° C.

The section fraction of particles 120 may be arranged on the second surface 212 of the core 201, optionally together with the binder 203 of the above described type.

After pressing, a building panel 210 is provided, wherein the second fraction of particles 120 together with the binder 203 form the surface layer, or form part of the surface layer by forming a sub-layer on which the wood veneer layer 202 is arranged.

Particles from the second fraction of particles may also be included in a process to form a core.

The third fraction of particles, which may be considered as a fine particle fraction, may be compacted into pellets. Such pellets may be used in combustion as pellet fuel.

The method, and subsequence methods and processes, are illustrated in the process chart in FIG. 7. Step 100 includes collecting the waste wood-based material as described above with reference to FIGS. 1 and 5. Step 101 includes screening the waste wood-based material through the first screen 3, or the first set of screens 3a, 3b, 3c, as described in FIGS. 1 and 5. The particles not passing through the first screen 3, or the first set of screens 3a, 3b, 3c, form the first fraction of particles, which are illustrated by 110 in FIG. 7. The first fraction of particles 110 may be ground, which is illustrated by 400 in FIG. 7, and thereafter may enter into the process again, as being collected and/or stored in step 100, and thereafter being screened again in step 101.

The particles passing through the first screen 3, or the first set of screens 3a, 3b, 3c, are thereafter screened through the second screen 4, or the second set of screens 4a, 4b, in step 102, as described above with reference to FIGS. 1 and 5. The particles not passing through the second screen 4, or the second set of screens 4a, 4b, form the second fraction of particles, which are illustrated by 120 in FIG. 7.

The second fraction of particles 120 may form the feedstock or raw material, such as being filler material, in a subsequent process, illustrated by step 200. In step 200, the second fraction of particles may be used for forming a building panel, or part of a building panel, as described above with reference to FIG. 6.

The particles passing through the second screen 4, or the second set of screens 4a, 4b, in step 102 form the third section of particles, which are illustrated by 130 in FIG. 7. In a subsequent step 300, the third fraction of particles may be compacted to pellets. Such pellets may be used as pellet fuel. As alternative or complement, the third fraction of particles may be combusted.

It is contemplated that there are numerous modifications of the embodiments described herein, which are still within the scope of the disclosure as defined by the appended claims. For example, it is contemplated that more than one wear resistant foil may be arranged on a core for forming a building panel.

### Example 1A: Screened Waste Wood-Based Material as Feedstock

Waste wood-based material in the form of saw and profiling waste from wood-based panels having a veneer surface layer was collected. The waste wood-based material was not processed prior to screening. The waste wood-based material was not grinded and was not dried prior to screening. 2 samples of fibres were produced from said wood-based waste material using 2 different production techniques.

Sample 1 was produced by running the whole waste-wood stream through a hammermill and screening the output through a 300 μm drum sieve. All particles passing through the screen were considered the utility fraction (second fraction of particles) and the particles not passing through the screen were considered coarse fraction (first fraction of particles). The amount of material in each fraction was estimated and is shown in Table 1.

TABLE 1
The amount of each fraction of sample 1.

| | Second fraction | |
|---|---|---|
| | (utility fraction, | First fraction |
| | passed through | (coarse fraction, |
| Amount of fractions | screen) | above screen) |
| Screen size (material on screen) | 0 μm | 300 μm |
| Mass distribution (wt %) | 80 | 20 |

Sample 2 was produced by screening the waste wood-based material in a screening device with a first set of screens, including screens A, B and C, and a second set of screens, including screens D and E, according to Table 2 below.

The 5 screens were at a non-zero angle relative to the horizontal plane and to the vertical plane. The material was fed in such a way that it entered the top of the screens, angled downwards so that the material was fed forward and through the screens by both gravity and vibrations from the sieve motor with a stroke length of 7.5 mm. The screening setup is explained in Table 2 and the amount yielded of each fraction is presented in Table 3.

TABLE 2
Screening setup to produce sample 2.

| Data | | | Resulting fraction |
|---|---|---|---|
| Screen width | 0.5 | m | |
| Feeding speed | 1128 | kg/min | |
| Aperture width screen A | 2000 | μm | First fraction (coarse) |
| Aperture width screen B | 720 | μm | First fraction (coarse) |
| Aperture width screen C | 450 | μm | First fraction (coarse) |
| Aperture width screen D | 315 | μm | Second fraction (utility) |
| Aperture width screen E | 200 | μm | Second fraction (utility) |
| | 0 | μm | Third fraction (fine) |

Particles not passing through screen A, screen B, or screen C form the first fraction of particles, i.e., the coarse fraction. Particles not passing through screen D or screen E form the second fraction of particles, i.e., the utility fraction. Particles passing through all screens A, B, C, D, E form the third fraction of particles, i.e., the fine fraction.

The amount of material in each fraction was measured according to Table 3.

TABLE 3
The amount of each fraction of sample 2.

| | Amount of fractions | | | | | | |
|---|---|---|---|---|---|---|---|
| | | Second | Second | First | First | First | Total |
| | Third | fraction | fraction | fraction | fraction | fraction | second |
| | fraction | (Screen E) | (Screen D) | (Screen C) | (Screen B) | (Screen A) | fraction: |
| Screen size | 0 μm | 200 μm | 315 μm | 450 μm | 720 μm | 2000 μm | |
| (material on | | | | | | | |
| screen) | | | | | | | |
| Mass | 18.5 | 15.5 | 19.1 | 20.9 | 22.9 | 3.1 | 35 |
| distribution | | | | | | | |
| (wt %) | | | | | | | |

Sample 1 and Sample 2 were then blended with a melamine formaldehyde resin and inorganic fillers in formulas presented in Table 4. For each blend, six 600 kg batches were produced and put into big bags. The formulas are presented in Table 4 below.

TABLE 4
Formulas made from fiber material 1, 2 and 3.

| | | Fiber | MF resin | Inorganic filler |
|---|---|---|---|---|
| | Fiber type | (wt %) | (wt %) | (%) |
| Blend 1 | Sample 1 | 45 | 47.5 | 7.5 |
| Bland 2 | Sample 2 | 45 | 47.5 | 7.5 |

The blends were then one by one discharged from the big bag into an air conveying system which conveyed the material for discharge into a scattering device and the scattering device scattered the blend onto a HDF board. The number of flowability related errors were counted for each blend type. The error types counted were:
Discharge issues, where the material was bridge building in the big bag, preventing it from entering the air conveying system.
Conveying issues, where the material formed a blockage in the air conveying pipes rather than flowing through it.
Scattering issues, for example, rat holing or bridge building in scattering machine, preventing it to be scattered onto the board.
   The results are shown in Table 5.

TABLE 5
Results of number of flow related processability issues.

| Test | Number of batches | Number of flowability |
|---|---|---|
| material | run during test | related errors |
| Blend 1 | 6 | 7 |
| Blend 2 | 6 | 0 |

As can be seen, when excluding the fine fraction from the utility fraction as in sample 2 there was a clear improvement of processability (ability to run through the process steps without flowability issues) where Blend 1 made from fibre type 1 exhibited the worst processability and Blend 2 made from fibre type 2 exhibited the best.

In Sample 1, the whole stream of waste-wood was run through a mill, whilst clearly around 35% of the infeed is already in a suitable utility fraction before grinding (according to screening results in Table 3). When grinding, the already suitable utility fraction risks size reduction into fine fraction (already 18.5% before grinding according to screening results in Table 3) which contribute to poor processability properties. Therefore, it is a much more reasonable operation to screen the waste wood stream than to grind it.

In an extended step, the coarse fraction from screening can be fed through the mill and again through the screening operation in order to optimize the yield of a high quality, highly processable fibre material.

### Example 1B: Screened Waste Wood-Based Material as Feedstock

Waste wood-based material in the form of saw and profiling waste from wood-based panels having a veneer surface layer was collected. The waste wood-based material was not processed prior to screening. The waste wood-based material was not grinded and was not dried prior to screening. One sample of fibres was produced from said wood-based waste material and compared to the materials in Example 1A. The purpose of the example was to show that this material, which is alike Sample 2 in Example 1A, can be sifted at different stroke lengths with maintained properties within the second fractions and where the material sifted at 3.0 mm stroke length exhibits roughly the same purity and yield as in Sample 2 in Example 1A which was sifted at 7.5 mm stroke length.

The sample was produced by screening the waste wood-based material in a screening device with a first set of screens, including screens A, B and C, and a second set of screens, including screens D and E, according to Table 6 below.

The five screens were at a non-zero angle relative to the horizontal plane and to the vertical plane. The material was fed in such a way that it entered the top of the screens, angled downwards so that the material was fed forward and through the screens by both gravity and vibrations from the sieve motor with a stroke length of 3.0 mm. The screening setup is explained in Table 26 and the amount yielded of each fraction is presented in Table 37.

TABLE 6
Screening setup to produce Sample 2.

| Data | | | Resulting fraction |
|---|---|---|---|
| Screen width | 0.5 | m | |
| Feeding speed | 828 | kg/min | |
| Aperture width screen A | 2000 | μm | First fraction (coarse) |
| Aperture width screen B | 720 | μm | First fraction (coarse) |
| Aperture width screen C | 450 | μm | First fraction (coarse) |
| Aperture width screen D | 315 | μm | Second fraction (utility) |
| Aperture width screen E | 200 | μm | Second fraction (utility) |
| | 0 | μm | Third fraction (fine) |

Particles not passing through screen A, screen B, or screen C form the first fraction of particles, i.e., the coarse fraction. Particles not passing through screen D or screen E form the second fraction of particles, i.e., the utility fraction. Particles passing through all screens A, B, C, D, E form the third fraction of particles, i.e., the fine fraction.

The amount of material in each fraction was measured according to Table 7.

TABLE 7
The amount of each fraction of Sample 2.

| | Amount of fractions | | | | | | |
|---|---|---|---|---|---|---|---|
| | | Second | Second | First | First | First | Total |
| | Third | fraction | fraction | fraction | fraction | fraction | second |
| | fraction | (Screen E) | (Screen D) | (Screen C) | (Screen B) | (Screen A) | fraction: |
| Screen size | 0 μm | 200 μm | 315 μm | 450 μm | 720 μm | 2000 μm | |
| (material on | | | | | | | |
| screen) | | | | | | | |
| Mass | 23.3 | 27 | 14.8 | 14.9 | 15.4 | 4.6 | 41.8 |
| distribution | | | | | | | |
| (wt %) | | | | | | | |

As can be seen in Table 7, the material was sifted with no screens being essentially empty which shows this screening was functional at 3.0 mm without material blockage on any one of the screens. Material blockage would be counted as any one of the screens exceeding 30% of the weight distribution. It is understood that the distribution over all screens is similar to Sample 2 from Example 1A. The distribution in combination with a high purity of the second fractions (utility fraction), meaning at least 60 wt. % of the particles are in the size of 100-400 μm, the utility fraction is considered as close to Sample 2 from Example 1A that it would exhibit essentially the same properties during production. Therefore, the purity of the utility fraction was measured by blending the two second fractions together, sampling and analysing according to the method described in Example 2.

TABLE 8
Utility fraction

| Analysis screens | Utility fraction | |
|---|---|---|
| (μm) | (wt. %) | |
| 0 | 14.4 | Contamination (fines) |
| 50 | 13.9 | Contamination (fines) |
| 100 | 35.3 | Correct fraction |
| 150 | 24.4 | Correct fraction |
| 200 | 7.9 | Correct fraction |
| 250 | 3.3 | Correct fraction |
| 300 | 0.8 | Correct fraction |

As can be seen in Table 8, the purity of the utility fraction (sum of correct fractions) is 71.7% and therefore, it can be considered close to Sample 2 from Example 1A. By this test it is determined that this material, which is alike Sample 2 in Example 1A, can be sifted at different stroke lengths with maintained properties within the second fractions and where the material sifted at 3.0 mm stroke length exhibits roughly the same purity and yield as in Sample 2 in Example 1A which was sifted at 7.5 mm stroke length.

### Example 2: Method Description of Sieving Analysis

All particle size measurements have been performed using the following equipment at the following settings:

Model name: Fritsch Analysette 3 PRO

Stroke length: 1.8 mm

Screen diameter: 200 mm

Screen distance=50 mm

Aperture size of each screen (from the bottom): 50 μm, 100 μm, 150 μm, 200 μm, 250 μm and 300 μm.

Sieving particle size: 0-50 μm, 50-100 μm, 100-150 μm, 150-200 μm, 200-250 μm, 250-300 μm and >300 μm

No. Of balls/screen: 5

Balls: ø20 mm rubber (No. 31.0180.15)

Material input: 50 g

Sieving time: 20 min

After sieving the 50 g of material, the material on each screen and the bottom was weighed and the weight percentage of each fraction calculated. The material passing through the 50 μm screen was classified as a sieving particle size of 0-50 μm, the material passing through the 100 μm screen but not the 50 μm screen was classified as 50-100 μm and so on.

### Item Section

1. A method to refine waste wood-based material, comprising
collecting a waste wood-based material resulting from sawing and/or machining in a wood-based material,
separating the waste wood-based material by particle size by screening the waste wood-based material through at least one first screen to separate a first fraction of particles from the waste wood-based material, wherein the at least one first screen has an aperture width of 3000 μm or less,
subsequently screening the waste wood-based material that has passed through the at least one first screen through at least one second screen to separate a second fraction of particles from the waste wood-based material, wherein the at least one second screen has an aperture width exceeding 50 μm, and
wherein a third fraction of particles is formed by particles from the waste wood-based material passing through the at least one second screen.

2. The method according to item 1, wherein separating the waste wood-based material by particle size by screening is made without prior grinding.

3. The method according to item 1 or 2, wherein the second fraction of particles is used as material in a method to produce a building panel, or a part of a building panel.

4. The method according to any one of the preceding items, wherein an average particle size of the second fraction of particles is less than an average particle size of the first fraction of particles and is exceeding an average particle size of the third fraction of particles.

5. The method according to any one of the preceding items, wherein aperture width of the at least one second screen is less than aperture width of the at least one first screen.

6. The method according to any one of the preceding items, wherein the at least one first screen is at a non-zero angle relative to a horizontal plane.

7. The method according to any one of the preceding items, wherein the at least one first screen comprises a set of first screens, wherein at least one of the first screens is at a non-zero angle relative to a horizontal plane.

8. The method according to any one of the preceding items, wherein the at least one second screen is at a non-zero angle relative to a horizontal plane.

9. The method according to any one of the preceding items, wherein the at least one second screen comprises a set of second screens, wherein at least one of the first second is at a non-zero angle relative to a horizontal plane.

10. The method according to any one of the preceding items, wherein at least 60% of the particles of the second fraction of particles have a size in a range of 100-400 μm.

11. The method according to any one of the preceding items, wherein the waste wood-based material is not dried prior to screening.

12. The method according to any one of the preceding items, wherein the moisture content of the waste wood-based material is at least 3% prior to screening.

13. The method according to any one of the preceding items, further comprising grinding the first fraction of particles.

14. The method according to any one of the preceding items, further comprising compacting the third fraction of particles to pellets.

15. The method according to any one of the preceding items, further comprising applying particles from the second fraction of particles and a binder on a substrate, and pressing to the particles, the binder, and the substrate to form a building panel, or a part of a building panel.

16. The method according to item 15, further comprising applying a wood veneer layer on the particles and the binder prior to pressing, wherein after pressing, the particles, the binder and the wood veneer layer form a surface layer of the building panel.

17. The method according to any one of the preceding items, where the at least one first screen has an aperture width in a range of 450 to 3000 μm, such as 720 to 3000 μm, such as 1000 to 3000 μm, such as 1500-2500 μm.

18. The method according to any one of the preceding items, where the at least one first screen comprises a set of first screens, wherein each first screen has an aperture width in a range of 450 to 3000 μm, such as 720-3000 μm, such as 1000 to 3000 μm, such as 1500-2500 μm.

19. The method according to any one of the preceding items, where the at least one second screen has an aperture width in a range of 50 to 600 μm, such as 50 to 450 μm, such as 50 to 400 μm.

20. The method according to any one of the preceding items, wherein the at least one second screen comprises a set of second screens, wherein each second screen has an aperture width in a range of 50 to 600 μm, such as 50 to 450 μm, such as 50 to 400 μm.

21. The method according to any one of the preceding items, wherein the at least one second screen comprises a set of second screens, wherein each second screen has an aperture width in a range of 150 to 450 μm.

22. The method according to any one of the preceding items, wherein the at least one first and/or second screen comprises chains arranged on the at least one first and/or second screen.

23. The method according to any one of the preceding items, wherein the at least one first and/or second screen is vibrating.

24. The method according to item 23, wherein the at least one first and/or second screen is vibrating with a stroke of 1.5-8 mm., such as 2-4 mm., or 7-8 mm.

25. The method according to any one of the preceding items, wherein the first fraction of particles is formed by particles not passing through the at least one first screen.

26. The method according to any one of the preceding items, wherein he second fraction of particles is formed by particles not passing through the at least one second screen.

27. The method according to any one of the preceding items, wherein the third fraction of particles is formed by particles passing through the at least one first screen and the at least one second screen.

28. The method according to any one of the preceding items, wherein the aperture width of the at least one screen may exceed the aperture width of the at least one second screen.

29. A method to recycle waste wood-based material, comprising
collecting a waste wood-based material resulting from sawing and/or machining in a wood-based material,
separating the waste wood-based material by particle size in an oversized fraction of particles, a fine fraction of particles, and a reusable fraction of particles by screening the waste wood-based material through one or more first screens having an aperture width of 3000 μm or less to separate the oversized fraction of particles,
subsequently screening a remainder of the wood-based material through one or more second screens having an aperture width of at least 50 μm to separate the reusable fractions of particles, and wherein the fine fraction of particles are formed by particles passing through the one or more second screens,
wherein the reusable fraction of particles forms feedstock in a process of producing a building panel.

30. A method to recycle waste wood-based material, comprising
collecting a waste wood-based material resulting from sawing and/or machining in a wood-based material,
separating the waste wood-based material by particle size by screening the waste wood-based material through at least one first screen (3; 3a, 3b, 3c) to separate a first fraction of particles from the waste wood-based material, wherein the at least one first screen (3; 3a, 3b, 3c) has apertures (12) having an aperture width (AW) of 3000 μm or less,
subsequently screening a remainder of the waste wood-based material through at least one second screen (4; 4a, 4b) to separate a second fraction of particles from the waste wood-based material, wherein the at least one second screen (4; 4a, 4b) has apertures (12) having an aperture width (AW) exceeding 50 μm, and
wherein a third fraction of particles is formed by particles from the waste wood-based material passing through the at least one second screen (4; 4a, 4b),
wherein the second fraction of particles forms feedstock in a process of producing a building panel.

31. The method according to item 30, wherein separating is performed without prior grinding.

32. The method according to item 30 or 31, wherein separating is performed without prior drying.

33. A method to recycle waste wood-based material, comprising
collecting a waste wood-based material resulting from sawing and/or machining in a wood-based material,
separating the waste wood-based material by particle size by screening the waste wood-based material through at least one first screen (3; 3a, 3b, 3c) to separate a first fraction of particles from the waste wood-based material, wherein the at least one first screen (3; 3a, 3b, 3c) has apertures (12) having an aperture width (AW) of 3000 μm or less,
subsequently screening a remainder of the waste wood-based material through at least one second screen (4; 4a, 4b) to separate a second fraction of particles from the waste wood-based material, wherein the at least one second screen (4; 4a, 4b) has apertures (12) having an aperture width (AW) exceeding 50 μm, and
wherein a third fraction of particles is formed by particles from the waste wood-based material passing through the at least one second screen (4; 4a, 4b),
applying particles from the second fraction of particles and a binder on a substrate, and
pressing to the particles, the binder, and the substrate to form a building panel, or a part of a building panel.

34. The method according to item 33, wherein separating is performed without prior grinding.

35. The method according to item 33 or 34, wherein separating is performed without prior drying.

36. A method to produce a building panel, comprising
applying a binder and particles from the second fraction of particles according to any one of the preceding items on a substrate,
applying heat and pressure on the binder and the second fraction of particles to the substrate to form a layer attached to the substrate.

37. The method according to item 36, further comprising applying a wood veneer layer on the binder and said particles prior to applying heat and pressure, wherein after applying heat and pressure, the binder and said particles form a sub-layer, arranged between the substrate and the wood veneer layer.

38. A building panel comprising a surface layer arranged on a substrate, wherein the surface layer comprises a binder and particles from the second fraction of particles from waste wood-based material obtained from the method according to any one of the preceding items.

39. The building panel according to item 38, wherein the surface layer comprises a wood veneer layer arranged on a sub-layer formed by the particles from the second fraction of particles and the binder, the sub-layer being arranged between the substrate and the wood-based material.

1. A method to refine waste wood-based material, comprising:
collecting a waste wood-based material resulting from sawing and/or machining in a wood-based material;
separating the waste wood-based material by particle size, without prior grinding, by screening the waste wood-based material through at least one first screen to separate a first fraction of particles from the waste wood-based material, wherein the at least one first screen has apertures having an aperture width of 3000 μm or less;
subsequently screening a remainder of the waste wood-based material through at least one second screen to separate a second fraction of particles from the waste wood-based material, wherein the at least one second screen has apertures having an aperture width exceeding 50 μm; and
wherein a third fraction of particles is formed by particles from the waste wood-based material passing through the at least one second screen.

2. The method according to claim 1, further comprising using the second fraction of particles as feedstock in a method to produce a building panel, or part of a building panel.

3. The method according to claim 1, wherein an average particle size of the second fraction of particles is less than an average particle size of the first fraction of particles and exceeds an average particle size of the third fraction of particles.

4. The method according to claim 1, wherein the aperture width of the at least one second screen is less than the aperture width of the at least one first screen.

5. The method according to claim 1, wherein the at least one first screen is at a non-zero angle relative to a horizontal plane.

6. The method according to claim 1, wherein the at least one second screen is at a non-zero angle relative to a horizontal plane.

7. The method according to claim 1, wherein at least 60% of the particles of the second fraction of particles have a size in a range of 100-400 μm.

8. The method according to claim 1, wherein the waste wood-based material is not dried prior to screening.

9. The method according to claim 1, further comprising grinding the first fraction of particles after screening.

10. The method according to claim 1, further comprising compacting the third fraction of particles to pellets after screening.

11. The method according to claim 1, where the at least one first screen comprises a set of first screens, wherein each first screen has apertures having an aperture width in a range of 450 to 3000 μm.

12. The method according to claim 1, wherein the at least one second screen comprises a set of second screens, wherein each second screen has apertures having an aperture width in a range of 50 to 600 μm.

13. The method according to claim 1, wherein the at least one first and/or the at least one second screen comprises chains arranged on the at least one first screen and/or the at least one second screen.

14. The method according to claim 1, wherein the at least one first screen and/or the at least one second screen is vibrating.

15. The method according to claim 14, wherein the at least one first and/or at least one second screen is vibrating with a stroke of 1.5-8 mm.

16. A method to recycle waste wood-based material, comprising:
applying particles from the second fraction of particles obtained by the method in claim 1 and a binder on a substrate, and
applying heat and pressure to the particles, the binder, and the substrate to form a building panel, or a part of a building panel.

17. The method according to claim 16, further comprising:
applying a wood veneer layer on the particles and the binder prior to applying heat and pressure, wherein after applying heat and pressure, the particles, the binder, and the wood veneer layer form a surface layer of the building panel.

18. A building panel, comprising a surface layer arranged on a substrate, wherein the surface layer comprises a binder and particles from the second fraction of particles obtained by the method according claim 1.

19. The building panel according to claim 18, wherein the surface layer comprises a wood veneer layer arranged on a sub-layer formed by the particles from the second fraction of particles and the binder.
